(19) United States
(12) Patent Application Publication
(10) Pub. No.: US 2025/0340276 A1
(43) Pub. Date: Nov. 6, 2025

(54) A MARINE SURROUND SENSING SYSTEM

(71) Applicant: CPAC SYSTEMS AB, Göteborg (SE)

(72) Inventors: Jonatan BERGENWALL, Mölndal (SE); David NYDAHL, Partille (SE); Hanna JONSSON, Partille (SE); Emma DAHLIN, Göteborg (SE)

(73) Assignee: CPAC SYSTEMS AB, Göteborg (SE)

(21) Appl. No.: 18/870,152

(22) PCT Filed: Jun. 8, 2023
(86) PCT No.: PCT/EP2023/065377

§ 371 Date: Nov. 27, 2024

(30) Foreign Application Priority Data
Jun. 8, 2022 (SE) 2250688-5

(51) Int. Cl. B63B 79/15; B63B 49/00; B63B 79/40; G01S 17/89; G01S 17/93; G06T 17/00; G06T 19/20; G06V 10/764; G06V 10/82; G06V 20/58; G06V 20/70

(52) U.S. Cl. CPC B63B 79/15; B63B 49/00; B63B 79/40; G01S 17/89; G01S 17/93; G06T 17/00; G06T 19/20; G06V 10/764; G06V 10/82; G06V 20/58; G06V 20/70; B63B 2203/00; G06T 2210/56; G06T 2219/2012

(57) ABSTRACT

A marine surround sensing system for controls a marine vessel. The marine surround sensing system has Light Detection And Ranging, LiDAR, sensors mounted around the marine vessel for registering surroundings of the marine vessel. The surroundings comprise obstacles and water. A control unit with neural network processes info about the registered surroundings which has been registered by the LiDAR sensors. The control unit is programmed to visualize the registered surroundings based on LiDAR data enriched by the neural network where the registered information has been classified into class objects in order to distinct between different types of objects in the surroundings.

### TECHNICAL FIELD

The disclosure relates to a marine surround sensing system for controlling a marine vessel. The disclosure relates to a marine surround sensing system that enriches sensed surrounding information with help of a neural network. It also focuses on a complete solution to visualize the surroundings and to aid the manoeuvring of a marine vessel. The disclosure can be implemented in all kinds of marine vessels.

### BACKGROUND

The marine environment is turbulent and chaotic as an effect of wind, drift, and waves. In such an environment it is crucial to have full awareness of the marine vessel surroundings to prevent collision and avoid danger. A system that is aware of the distance to the surrounding obstacles and water can use this information to aid the captain. However, as the water is ever changing, and the marine vessel moves in all three directions the information is difficult to interpret into useful aid. If the system also is aware of what kind of obstacle or water that is present, the aid and helping functions can be of much higher precision. Human Machine Interface (HMI) support for free space and marked known objects is one example. Another is preventing manoeuvres that would lead to collision with an object such as dock or another marine vessel. Finally, this could be evolved further into an Advanced Driving/Advanced Driver Assistance System (AD/ADAS).

A marine vessel with a control system can greatly benefit from this making it even easier to dock a marine vessel and avoid collision.

### Existing Solutions

An existing solution is a surround view camera system that gives visualization of the closest area around the marine vessel based on cameras. Such system is suitable for docking. However, the system cannot see far and the projection makes the stitched image difficult to interpret.

Another existing solution is a radar sensor system to interpret and classify objects and free space. The radar sensor system is for mainly autonomous vehicles, not marine vessels. However, it has low resolution measurement with noise and it needs a camera to perform classification.

Another existing solution is a system which senses the surroundings with stereo cameras and integrates it to the assisted docking. This system can perceive surroundings closer than 10 meters, but not a larger part of the harbour.

US20,210,88667A1 only covers the surround view of the water line. It discloses to detect structures across a region by vertically scanning the region using the LIDAR sensors. In

paragraph it is mentioned that “Embodiments of the technology apply to the field of marine vessel navigation systems using LIDAR sensors. Using LIDAR sensors that utilize a near infrared spectrum that is undetectable to the human eye can enable a navigation system in a marine environment to identify docks, boats, and shorelines by differentiating objects from the water as water typically has a detectable LIDAR signature.” Thus, here it is referred to the intensity value from LiDAR which is not always enough to accurately differentiate different objects. In this prior art, only objects near the surface of the water would be detectable but this is still useful, for example, in the case of detecting swimmers in the vicinity of the propeller.

U.S. Pat. No. 9,778,657B2 discloses a method of automatically moving, by an automatic location placement system, a marine vessel. The method includes receiving, by a central processing unit, from a vision ranging photography system, at least one optical feed including data providing a mapping of an environment surrounding a marine vessel. The method includes displaying, by the central processing unit, on a touch screen monitor, the mapping of the environment. The method includes receiving, by the central processing unit, from the touch screen monitor, target location data. The method includes directing, by the central processing unit, at least one element of a propulsion system of the marine vessel, to move the marine vessel to the targeted location, using the mapping. In this prior art cameras are used.

KR20200027870A discloses an autonomous navigation method using image segmentation, capable of detecting a surrounding environment using an artificial neural network which performs image segmentation. It discloses an autonomous navigation method for a vessel using a maritime image and an artificial neural network. The method comprises the steps of: obtaining labelling data; outputting output data; learning an artificial neural network using an error function; obtaining a maritime image; obtaining information on the type and distance of an obstacle; obtaining information on the direction of the obstacle included in the maritime image; obtaining the position of the obstacle included in the maritime image; generating an obstacle map; generating a following path; and generating a control signal. Also here only cameras are used.

US20,210,12120A1 discloses a system and method for estimating free space including applying a machine learning model to camera images of a navigation area, where the navigation area is broken into cells. The method comprises synchronizing point cloud data from the navigation area with the processed camera images, and associating probabilities that the cell is occupied and object classifications of objects that could occupy the cells with cells in the navigation area based on sensor data, sensor noise, and the machine learning model. Also here only cameras are used.

Scientific Paper “Exploiting Structured CNNs for Semantic Segmentation of Unstructured Point Clouds from LiDAR Sensor” (https://www.mdpi.com/2072-4292/13/18/3621/htm) discloses a projection-based method for semantic segmentation of 3D point clouds as such. A trained convolutional neural network (CNN) estimates the class-value for each LiDAR point based on the depth and intensity values.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### SUMMARY

An object of the disclosure is to provide a marine surround sensing system for controlling and docking a marine vessel by a system that can help the user to interpret the surroundings in a better way, or that can be used to automatically control a driveline of a marine vessel.

According to a first aspect of the disclosure, the object is achieved by a marine surround sensing system for controlling a marine vessel, wherein the marine surround sensing system comprises:
LiDAR sensors mounted around the marine vessel for registering surroundings of the marine vessel, wherein the surroundings comprise obstacles and water,
a control unit with a neural network to process information about the registered surroundings which has been registered by the LiDAR sensors,
   where the control unit is programmed to visualize the registered surroundings based on LIDAR data enriched by the neural network where the registered information has been classified into class objects in order to distinct between different types of objects in the surroundings.

The marine surround sensing system may comprise a helm station to visualize the registered surroundings and to provide input for manually controlling a driveline of the marine vessel.

The classified information may be disclosed as a 3D point cloud visualization with positional information and class information.

The classified information may be disclosed as a probability map.

The probability map may be a two-dimensional (2D) point cloud visualization with positional information and class information.

The probability map may be a three-dimensional (3D) point cloud visualization with positional information and class information.

The classification may be done with a projection-based method for semantic classification of 3D point clouds.

Each point in the visualizations may be coloured with a colour of a class object.

The control unit may make decisions adapted to the visualized objects nearby the marine vessel, depending on their class objects.

The control unit may be arranged to make decisions in such a way that;
a. if there is another marine vessel within a predetermined distance, the control unit automatically lowers the speed of the marine vessel below a predetermined speed to avoid getting too close to the other marine vessel, while,
b. if instead a dock is registered, the control unit if appropriate is allowed to drive faster than the predetermined speed when approaching the dock, since a dock is not a movable object compared to the other marine vessel.

According to a second aspect of the disclosure, the object is achieved by a marine vessel comprising the marine surround sensing system according to the first aspect.

According to a third aspect of the disclosure, the object is achieved by a computer implemented method for controlling a marine vessel. The method comprising:
obtaining information about registrations of the surroundings of the marine vessel, wherein the registering is performed by LiDAR sensors mounted around the marine vessel, wherein the surroundings comprise obstacles and water;
processing, using a neural network, information about the registered surroundings which has been registered by the LiDAR sensors; and
visualizing the registered surroundings based on LiDAR data enriched by the neural network where the registered information has been classified into class objects in order to distinct between different types of objects in the surroundings.

Controlling and docking a marine vessel can be difficult tasks as the marine environment is ever changing. With a marine surround sensing system according to the disclosure that helps the user to interpret the surroundings this can be made easier. With LiDAR sensors the surrounding environment can be interpreted by measuring the 3D-position and intensity value of a light reflection. By interpreting each LiDAR measurement into a class object, e.g. water, dock, marine vessel etc., using a neural network, the surrounding environment can be interpreted. Furthermore, obstacles as other marine vessels and docks can be distinguished. This data can then be visualized in an HMI as a probability map that presents the probable surrounding view in relation to the marine vessel.

A marine vessel with a control system can greatly benefit from this making it even easier to dock a marine vessel and avoid collision.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary schematic diagram illustrating a marine vessel according to an example.

FIG. 2 is an exemplary schematic diagram illustrating a marine vessel according to an example.

FIG. 3 is an exemplary flow chart illustrating a method according to an example.

FIG. 4 is an exemplary schematic illustration of a marine vessel at a dock according to an example.

FIG. 5 is an exemplary schematic illustration of a marine vessel in a canal according to an example.

FIG. 6 is an exemplary schematic illustration of a marine vessel with different objects in the surroundings according to an example.

FIG. 7 is a flow chart of an exemplary method according to an example.

FIG. 8 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

This disclosure has a focus of enriching the surrounding information with help of a neural network. It also focuses on a solution to visualize the surroundings of the marine vessel and aid the manoeuvring of the marine vessel. In this way the disclosure is more sophisticated and advanced such that it can adapt better to every situation.

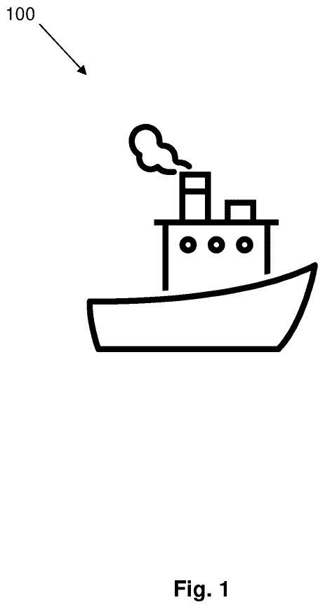

FIG. 1 is an exemplary block diagram illustrating a marine vessel 100. The marine vessel 100 may be any kind of marine vessel, such as boat, marine leisure craft, jet ski, personal watercraft, ship, tanker, freighter, submarine etc. The marine vessel 100 may be referred to as a water vessel, waterborne vessel, water vehicle etc. Although the disclosure may be described with respect to a particular marine vessel, the disclosure is not restricted to any particular marine vessel.

The marine vessel 100 is arranged to be steered and controlled by a user. The user may be referred to as a captain, an operator, a controller. The user may be a human user or a non-human user, e.g. a computer or computer system, in case the marine vessel is an at least partly autonomously controlled marine vessel. Steering the marine vessel 100 may be referred to as operating the marine vessel 100, driving the marine vessel 100 etc.

The marine vessel 100 comprises a marine surround sensing system. The marine surround sensing system is arranged to sense surroundings of the marine vessel 100. The surroundings of the marine vessel 100 may comprise one or more objects, also referred to as obstacles, which the marine vessel 100 may need to give way for, for example by changing its travel trajectory, to adapt its speed, etc. The objects may be of different types, for example another boat, a dock, a canal border, a buoy, water etc. Each object type may be associated with a class or an object class, or the object type may be a class or an object class.

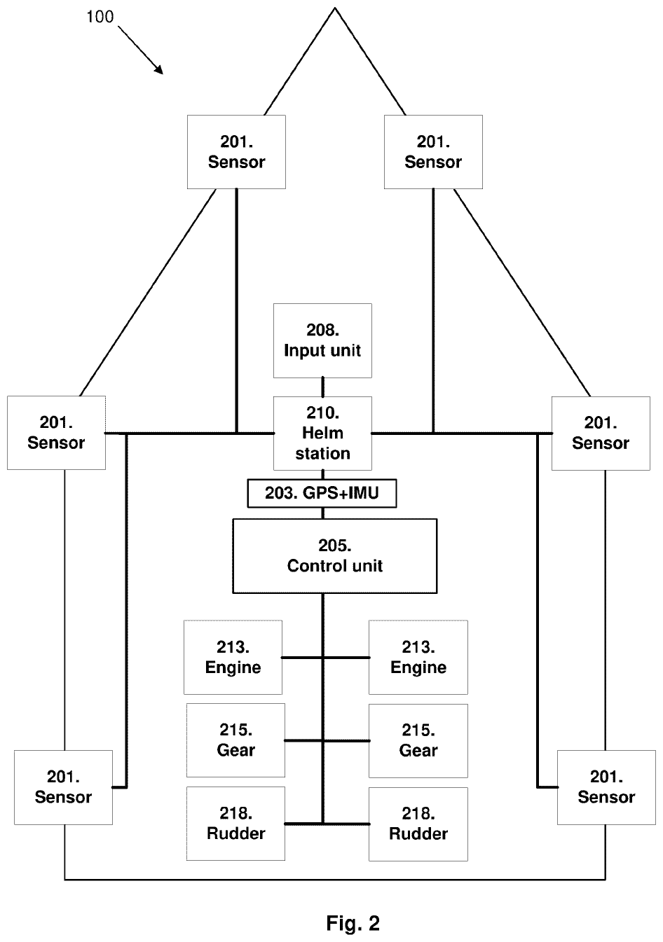

FIG. 2 is an exemplary schematic diagram illustrating the marine vessel 100 according to an example. The marine vessel 100 comprises the marine surround sensing system.

The marine surrounding sensing system comprises n number of LiDAR sensors 201, where n is a positive integer. The LiDAR sensors 201 are arranged to be mounted around the marine vessel 100 arranged to register surroundings of the marine vessel 100, i.e. to sense the surroundings of the marine vessel 100. The LiDAR sensors 201 may be mounted in the hull of the marine vessel 100, e.g. integrated in the hull, or on the outside of the hull. The position of the LiDAR sensor 201 may depend on the size and structure of the marine vessel 100. LiDAR sensors 203 are sensors suitable for marine applications. Each LiDAR sensor 201 is arranged to record reflected laser pulses as a collection of points, i.e. a point cloud. A point cloud refers to a set of data points in a 3D coordinate system. Thus, the output of a LIDAR sensor 201 is a point cloud, i.e. a 3D point cloud. Each data point in the 3D point cloud is represented by cartesian coordinates x, y, z.

The LiDAR sensors 201 has higher resolution than for example radar and sonar sensors. The LiDAR sensors 201 are more accurate than cameras for measuring depth. Multiple LiDAR's sensors 201 may be mounted on the marine vessel 100 to cover all surrounding angles and leave no blind spots. The LiDAR sensors 201 may be arranged to sense distance for example up to 120 meters, but a marine vessel 100 can also be equipped with LiDAR sensors 201 that can sense longer and/or shorter distances than the exemplified distance. FIG. 2 illustrates an example where six LiDAR sensors 201 are mounted around the marine vessel 100, but any n number of LiDAR sensors 201 are applicable, where n is a positive integer. As exemplified in FIG. 2, three LiDAR sensors 201 may be mounted on the port side of the marine vessel 100 and three LiDAR sensors 201 may be mounted on the starboard side of the marine vessel 100. Even though the example in FIG. 2 illustrates that the LiDAR sensors 201 are evenly distributed around the marine vessel 100, this is only an example. The LiDAR sensors 201 may be distributed in any suitable fashion around the marine vessel 100, e.g. evenly or unevenly distributed.

Depending on the size and shape of the marine vessel 100, different number of LiDAR sensors 201 may be needed to ensure no blind spots. The LiDAR sensor types can also vary on the marine vessel 100 such that there are some LIDAR sensors 201 arranged to see far and some shorter. The same goes for the number of drivelines and thrusters, where the amount is chosen depending on size and shape of the marine vessel 100.

The marine surround sensing system may comprise a Global Positioning System (GPS) and Inertial Measurement Unit (IMU) 203. The GSP and IMU 203 are arranged to give positional data of marine vessel 100 needed to for example compensate LiDAR measurements to movements when translating to an HMI map view. In this way, old LIDAR measurements can be visualized for some time even if the marine vessels 100 move far away. The marine vessel 100 has moved far away when it has moved a pre-determined distance from the measured point, and then it is removed from memory (not illustrated in FIG. 2) of the marine surround sensing system. The marine surround sensing system may have a memory of where obstacles were detected.

The marine surround sensing system comprises a control unit 205. The control unit 205 may be a computing unit or it may comprise a computing unit. The control unit 205 may comprise a Neural Network (NN) which is arranged to make the previous LiDAR measurements richer of information such that it is possible to create smarter and more accurate aid functions. The neural network may be referred to as a semantic segmentation network or arranged to perform a sematic segmentation method. The point cloud from the LiDAR sensors 201 is projected into two 2D maps with the depth and intensity values for the panorama view around the marine vessel 100. The terms map and image may be used interchangeably herein. The two 2D maps may comprise a first 2D map comprising depth information and a second 2D map comprising intensity information. The depth information comprises a distance to each 3D point in the 3D point cloud and the intensity information comprises a reflectivity value, e.g. energy return, of each (x,y,z) 3D point in the 3D point cloud. These two 2D maps may be processed in a neural network, e.g. a pre-trained convolutional neural network, that estimates a 2D map with class information for each measurement point. The estimated 2D map with class information can be projected back to the point cloud, i.e. the 3D point cloud, giving it one new characteristic of class value, this may be referred to as a segmentation part.

Segmentation may be described as point classification. Segmentation may comprise classifying each pixel or point in an image or a point cloud to a class. In this way, all areas of the image or point cloud may be divided to belong to different classes or types of objects.

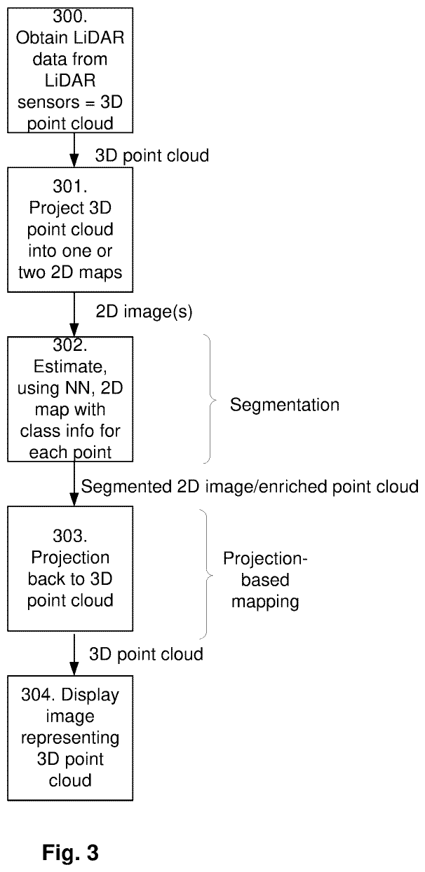

The estimated 2D map with class information that is projected back to the point cloud may be referred to as an enriched point cloud, i.e. the estimated 2D map being enriched with class information. The enriched point cloud can then be used to present a more detailed view or visualization, increased safety features to avoid collision and other functions that need good interpretation of the surroundings of the marine vessel 100. This method may be called projection-based mapping. The neural network needs to be trained on labeled data to be able to predict the correct classes. The labeled data must be recorded and labeled as a separate action before training is possible. The labeled data is or comprises the ground truth data of class information for the point cloud, used to train the neural network. Readings from the LiDAR sensors 201 can be removed depending on what class they belong to. For example, a point of the class ‘Water’ can be removed to easier detect objects near the waterline that previously would have been removed with a height filter. An object may be referred to as an obstacle, i.e. an obstacle that the marine vessel 100 may need to give way for, to avoid colliding with etc. The above is schematically illustrated in the exemplary flow chart in FIG. 3. The steps in FIG. 3 may be performed by the control unit 205 or a processing circuitry comprised in a computer system. Summarized, the method illustrated in FIG. 3 comprises at least one of the following steps, which steps may be performed in any suitable order than described below:

### Step 300

LiDAR data from the LiDAR sensors 201 are obtained, for example transmitted from the LiDAR sensors 201 to the control unit 205. LiDAR data from only the LiDAR sensors 201 may be obtained. The LiDAR data may be referred to as a 3D point cloud or comprised in a 3D point cloud. Before the LiDAR data are obtained, the LiDAR sensors 201 senses or registers the surroundings of the marine vessel, and the registrations are referred to as LIDAR data.

### Step 301

The 3D point cloud from step 301 is projected into one or two 2D maps. In the case of two 2D maps, there may be a first 2D map comprising depth information and a second 2D map comprising intensity information. In the case of one 2D map, the 2D map may comprise either depth information or intensity information. Using other words, one image with one or two channels may be created, where the two channels are associated with depth and intensity, respectively, and where the one channel is associated with either depth or intensity.

### Step 302

Based on the one or two 2D maps from step 301, a 2D map with class information for each point is estimated. The estimation may be performed using a neural network. This step may also be referred to as a performing segmentation. The output of step 302 is an enriched point cloud, i.e. a segmented 2D image.

Using other words, a 2D map may be created from one of the depth or intensity map or with both of them as an image with 2 channels. Any of these three image types may be the input to the neural network.

The neural network may classify a 2D class information map based on the first 2D map representing depth or the second 2D map representing intensity, or both of them. Thus, the classification may use only depth information or only on intensity information as input, or it may use a combination of depth and intensity information as input.

The term segmentation used herein may be described as an image or point cloud where, besides the position/colour/depth/intensity information, there is also information regarding what type of object or class each pixel or point belongs to. So the neural network may in step 302 predict the class of each pixel or point from a 2D image input into a class information output as an 2D image. Then to get the point cloud again it may be necessary to transform it back again to the 3D domain with the already known depth information, which is described below in step 303.

Step 302 may comprise to determine a probability associated with each pixel or point in the 2D image. As mentioned above, the LiDAR data comprises points in a 3D point cloud with an x, y and z value. These points may be translated down to a 2D plane in line with the water surface and/or the marine vessel 100 and thereby create measurements in a 2D plane. A 2D plane may be divided into squares of any suitable size, e.g. 0.1 m*0.13 m, 0.2 m*0.2 m, 0.3 m*0.3 m, 0.4 m*0.4 m. For each LiDAR measurement point that is translated to a square in the 2D plane, the probability for the presence of something in this square/position is increased. At a first number of measurement points in the same position, a first probability may be displayed. A second number of measurement points in the same position may correspond to a maximum probability. The first number may be for example 3 measurement points and the second number may be for example 8 measurement points. Each time there are no measurement points in such square, but it is determined that the square is not blocked by an object in front of it, then the probability is reduced in the same way.

### Step 303

The enriched point cloud from step 602 is projected back to the 3D point cloud. This step may be described as a projection-based mapping, i.e. a mapping from the segmented 2D image to the 3D point cloud.

### Step 304

An image or a map representing the 3D point cloud from step 303 may be displayed, for example in a display comprised in the marine vessel 100. The display may be comprised in the helm station 210 or connected to the helm station 210. Each point in the image or map representing the 3D point cloud may be coloured with a colour corresponding to a class object. Instead of or in addition to a colour, any other suitable representation of a class object may be used, for example dots, diagonal lines etc.

The displayed image or map may be a probability map comprising the probability determined in step 302.

Using other words, step 304 may be described as displaying the registered surroundings based on LiDAR data enriched by the neural network where the registered information has been classified into class objects in order to distinct between different types of objects in the surroundings.

Based on the displayed image or map, the control unit 205 may, for example if the marine vessel 100 is an at least partly autonomous marine vessel, for example determine to control the marine vessel 100 depending on the classes of the objects in the surroundings. For example, the speed of the marine vessel 100 may be lowered, it may be increased etc., depending on which class of object that is in the surroundings of the marine vessel 100. In another example, the displayed image or map may assist the user in operation of the marine vessel 100, e.g. assisted docking.

Now returning to FIG. 2.

The marine surround sensing system may comprise an HMI and a steering system. By combining LiDAR measurements and segmentation with the electric control system of the marine vessel 100 and associated HMI the functionalities can be especially useful. Docking of the marine vessel 100 can be made easier with helping functions that consider what kind of obstacles are present around the marine vessel 100. The marine surround sensing system can prevent actions from the user of the marine vessel 100 that may lead to collision. With the full integration from LiDAR sensors 201 to control unit 205 functions, autonomous driving of the marine vessel 100 can be further developed and implemented. However, as a start this is mainly targeted to be aiding functions.

The marine surround sensing system may comprise an input unit 208 arranged to receive user input. The input unit 208 may be in the form of a joystick or other directional device to input the desired motion of the marine vessel 100 to the marine surround sensing system. Another example of the input unit 208 may be an HMI display arranged to obtain user input which can be used to for example activate or deactivate and control functionalities. The HMI display may be an HMI touch screen.

The marine surround sensing system may comprise an actuator (not illustrated in FIG. 2). There may be one or more actutors. If there are multiple actuators, then they can be controlled individually to generate the same force directionas as the user input. Force directions to prevent collision and danger can also be given autonomously from the marine surround sensing system.

The marine surround sensing system may comprise a compass (nott illustrated in FIG. 2), for example a Global Navigation Satellite System (GNSS) compass, which may be used to provide information about the marine vessels' heading and position to the control unit 205. The positional information may be used to move the map and translate the LiDAR measurements accurately to the marine vessel 100.

The marine surround sensing system may comprise a computing unit which may be a standalone unit or comprised in the control unit 205. The computing unit is arranged to predict a class value for each LiDAR measurement with use of a pre-trained neural network. The class value in combination with the 3D position and intenisty value is used to interpret the surroundings. This information may then sent to a helm station 210 where the user can view information about the surrounding environment. User input that would lead to probable collision can be neutralized. In addition, readings from the LiDAR sensors 201 can be removed depending on what class they belong to. For example, points of the class ‘Water’ can be removed to easier detect objects near the waterline.

The marine surround sensing system may comprise a HMI (not illustrated in FIG. 2) arrranged to show a probability map of the surroundings based on the enriched LiDAR data with class information. Showing water, docks, other marine vessels etc. in different ways to increase the information of what the surroundings looks like. The probability of obstacles may also be presented with distinct colors or other representations depending of how confident the marine surround sensing system is about the region. A 3D view can be switched to where the user may see the 3D point cloud with distinct colors or other representations based on class value. For example, marine vessels may be represented by the colour blue, docks may be represneted by the colour red etc. Touch gestures can be input from the user to set functions and interact with the 2D and 3D maps.

With the complete marine surround sensing system, the user is given better awareness of the marine vessel surroundings. Where it is free to go, where the marine vessel fits and where collision is probable can be visualized. The marine surround sensing system can also aid by prevent user input that would lead to collision and assist to keep an even distance to objects around the marine vessel 100.

By increasing information with class values of the LiDAR measurements it is also possible to create docking functions. As different docking positions require different techniques to dock it is an advantage that the marine surround sensing system can identify the situation. Docking at a dock, beside another marine vessel or right next to a cliff are three examples of different situations where the type of obstacles plays a significant role in how to dock the marine vessel 100.

An autopilot that follows other marine vessels and keeps the distance to them can be made more robust by identifying what is marine vessel, water, and other obstacles instead of just measuring the distance to them.

FIG. 2 further illustrates that the marine vessel 100 comprises two engines 213, two gears 215 and two rudders 218. Note that the number of engines 213, gears 215 and rudders 218 illustrated in FIG. 2 are only examples, and that the marine vessel 100 may comprise any suitable number of engines 213, gears 215 and rudders 218. The number of engines 213, gears 215 and rudders 218 may be the same or it may be different. The marine vessel 100 may comprise at least one engine 213, at least one gear 215 and at least one rudder 218.

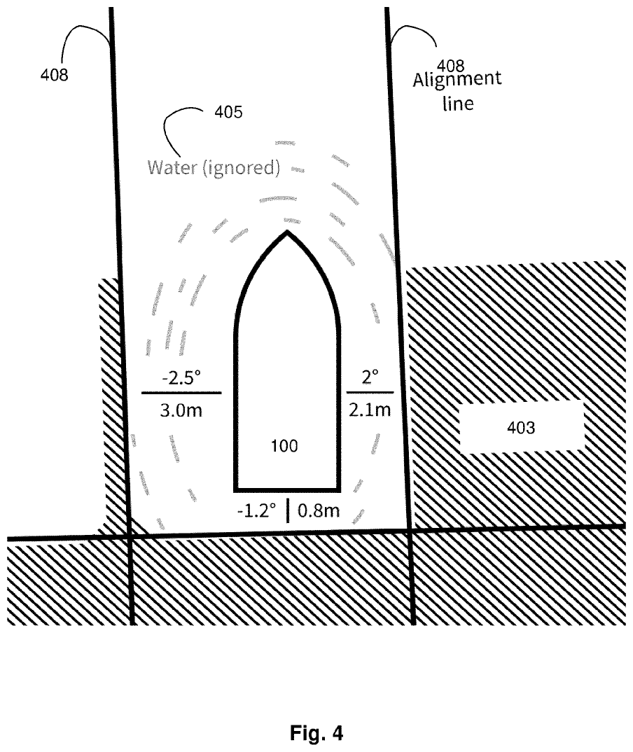

FIG. 4 is an exemplary schematic illustration of a marine vessel 100 at a dock 403. The example illustration seen in FIG. 4 may be displayed on the HIM, for example comprised in the helm station 210 or connected to the helm station 210.

The dock 403 is represented using diagonal lines. Instead of diagonal lines, a certain colour may be used to represent the dock 403, for example the colour red. Water 405 is represented by curved lines around the marine vessel 100, or for example the colour blue. An alignment line 408 is located on each side of the marine vessel 100 and represents the trajectory of the marine vessel 100. The white space in FIG. 2 can represent “free space” where it is safe to go, and the parts with diagonal lines are probable collision areas where the marine surround sensing system should prevent the marine vessel 100 from going to. The LiDAR measurements of the water 405 is removed with help of the neural network's predicted class of water 405 such that the marine surround sensing system can understand where it is safe to go. The dock 403 is also classified and can hence be treated as a dock by the marine surround sensing system. The marine surround sensing system may also be configured to determine the distance between the marine vessel 100 and the dock 403. As the example illustrated in FIG. 4, the distance between the starboard side of the marine vessel 100 and the dock 403 may be 2.1 m and the angle difference index may be 2°, the distance between the port side of the marine vessel 100 and the dock 403 may be 3.0 and the angle difference index may be −2.5°. The distance between the aft of the marine vessel 100 and the dock 403 may be 0.8 m and the angle difference index may be −1.2°. The angle difference index represents the angle difference between a vessel side and a closest object side if there is an edge detected.

A 3D point cloud of different class objects may be visualized which can specify to the marine surround sensing system what is located nearby the marine vessel 100. The 3D point cloud may be displayed in an HMI, e.g. in the helm station 210 or connected to the helm station 210. For example, lighter blue colours may indicate other marine vessels while the red areas may indicate docks 403. In another example, dotted objects may represent other marine vessels, objects filled with diagonal lines may represent the dock 403, and rounded lines may represent water 405. By interpreting the difference of these objects, the speed or other parameters of the marine vessel 100 can be adjusted. The object recognition can help to avoid collisions and enable the knowledge of the surroundings in a higher level.

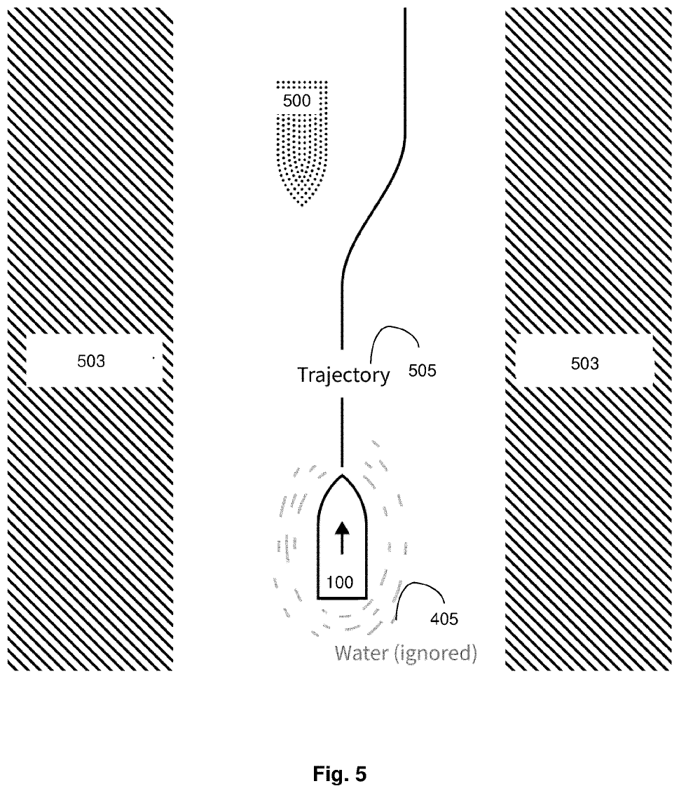

FIG. 5 is an exemplary schematic illustration of a marine vessel 100 traveling in a canal. The marine surround sensing system may comprise a canal lane keeping aid that can be created with the use of a free space algorithm that can be more stable with the help of the class information. The marine vessel 100 travels in the canal and gives way for another marine vessel 500, e.g. an oncoming marine vessel, by that the marine surround sensing system understanding the difference between the other marine vessel 500 and the canal border 503. The canal border 503 is represented by diagonal lines and the other marine vessel 500 is represented by dots. The water 405 is represented by curved lines and may be ignored. The trajectory 505 of the marine vessel 100 is also illustrated in FIG. 5.

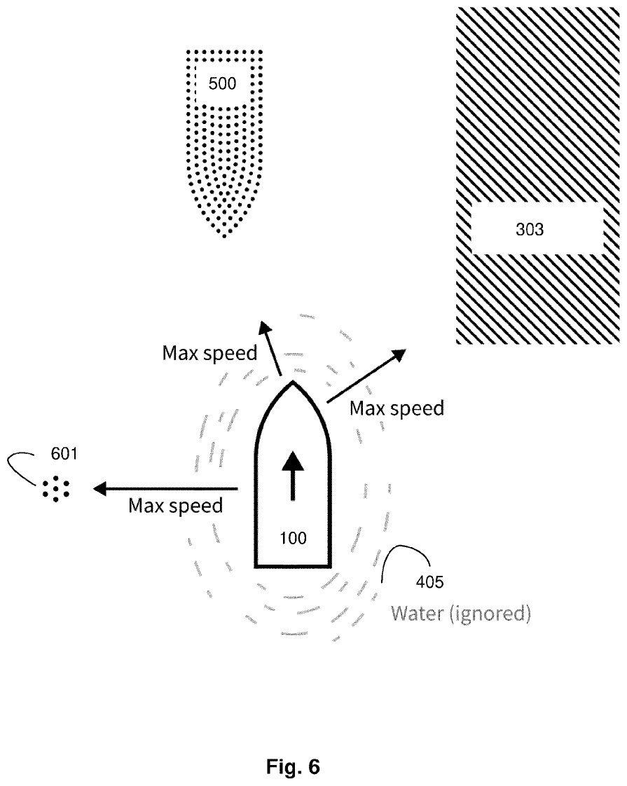

FIG. 6 is an exemplary schematic illustration of how the marine surround sensing system may utilize information about different objects in the surroundings for adjusting the maximum speed of the marine vessel 100 that it is allowed to have in the direction towards a certain type of object. The maximum speed towards the respective type of object may be different or the same. FIG. 6 shows that the surroundings may comprise objects of different types. The object types that are exemplified in FIG. 6 are another marine vessel 500, a dock 403, water 405 and a buoy 601. The other marine vessel 500 is represented by dots, the dock 403 is represented by diagonal lines, the water 405 is represented by curved lines and the buoy is represented by dots which are larger than the ones representing the other marine vessel 500.

By using LiDAR data, the computational speed and distance accuracy can be improved considerably. Cameras have less distance accuracy and require more computational power, as compared to LiDAR sensors 201. LiDAR sensors 201 also detect better in darkness or bad weather compared to cameras. Other sensors such as radar or sonar have lower resolution than LiDAR sensors 201, making it difficult to retrieve enough information about the surroundings.

The marine surround sensing system uses semantic segmentation based on LiDAR data, e.g. solely on LiDAR data. In combination with the marine environment, HMI-features and an electric control system, a complete marine surrounding sensing system of high value is created.

The marine surround sensing system may provide an HMI-view of a probability map around the marine vessel 100 that is based on LiDAR data, e.g. solely on LiDAR data. LiDAR data gives the possibility to present a map-view for a larger area, e.g. around 100 m radius, whereas the previously known systems are limited to around 15-meter radius around the marine vessel 100.

The LiDAR sensors 201 used in the marine surround sensing system may have for example 32 layers in 70° vertical Field of View (FOV) giving more than 1 million points/second for each LiDAR sensor 201. This makes it possible to not only raise attention to closest distance around the marine vessel 100 in some angles, but also to show all the data of the surroundings.

The marine surround sensing system enables to present a 3D view in the HMI with positional and class information. Such a view is detailed enough to make it possible for the user to navigate the marine vessel 100 by only looking at the HMI. The marine surround sensing system may present a 2D probability view where the probability of surrounding obstacles is visualized.

With the segmented point clouds, the marine surround sensing system may take decisions adapted to the nearby objects, depending on their classes. If there is another marine vessel 500 within a predetermined distance, the marine surround sensing system can automatically lower the speed of the marine vessel 100 and avoid getting to close to the other marine vessel 500, while if a dock 403 is detected, the marine surround sensing system can trigger the marine vessel 100 to drive faster, compared to when approaching another marine vessel 500, when closing up to the dock 403, since a dock 403 is not a movable object compared to another marine vessel 500.

With the marine surround sensing system, it is possible to present a 3D view where each point is colored with the class value, or where each point is represented with a certain fill pattern or any other representation. The fill pattern may be for example dots, diagonal lines, horizontal lines, vertical lines, stars etc. This gives a good overview of the surroundings of the marine vessel 100 even if it is dark outside. This feature can decrease the number of times the user of the marine vessel 100 would otherwise have to temporarily leave the helm station 210 to go and check distance to obstacles around that are close to the marine vessel 100, such as other marine vessels 500, dock 403, etc. Thus, the marine surround sensing system provides good understanding of the surroundings decreases the need to have to leave the helms station 210 and/or control of the marine vessel 100, making the driving of the marine vessel 100 safer.

The marine surround sensing system has a classification intelligence, it integrates with the control system and enables a dynamic HMI functionality.

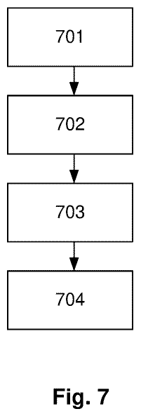

FIG. 7 is a flow chart of an exemplary method according to an example. The method may be performed by the control unit 205 or the marine surround sensing system or a processing circuitry comprised in a computer system. The method comprises at least one of the following steps, which steps may be performed in any suitable order than described below:

### Step 701

This step corresponds to step 300 in FIG. 3. Information about registrations of the surroundings of the marine vessel 100 is obtained. The information about the registrations may be obtained from the LiDAR sensors 201. The registering is performed by LiDAR sensors 201 mounted around the marine vessel, e.g. by only using LiDAR sensors. The surroundings comprise obstacles 403, 500, 503, 601 and water 405.

### Step 702

This step corresponds to steps 301, 302, 303 in FIG. 3. The information about the registered surroundings which has been registered by the LiDAR sensors is processed using a neural network. The processing may comprise to perform a segmentation, which has been described in detail above.

Step 702 may comprise to enrich the registered surroundings based on LiDAR data neural network. Enrichment of the registered surroundings based on LiDAR data may comprise to classify the registered information into class objects in order to distinct between different types of objects 403, 500, 503, 601 in the surroundings. The output of step 702 may be described as classified information which comprises information about which class an object has been classified into, i.e. which class an object belongs to. Examples of classes may be: water 405, dock 403, another marine vessel 500, canal border 503, buoy 601 etc. Other examples of classes may be moving object, stationary or non-moving object, etc.

Step 702 may comprise to determine probability. A probability associated with each pixel or point in the 2D image may be determined. As mentioned above, the LiDAR data comprises points in a 3D point cloud with an x, y and z value. These points may be translated down to a 2D plane in line with the water surface and/or the marine vessel 100 and thereby create measurements in a 2D plane. A 2D plane may be divided into squares of any suitable size, e.g. 0.1 m*0.13 m, 0.2 m*0.2 m, 0.3 m*0.3 m, 0.4 m*0.4 m For each LIDAR measurement point that is translated to a square in the 2D plane, the probability for the presence of something in this square/position is increased. At a first number of measurement points in the same position, a first probability may be displayed, for example color coded from blue to red. A second number of measurement points in the same position may correspond to a maximum probability. The first number may be for example 3 or more measurement points and the second number may be for example 8 measurement points. Each time there are no measurement points in such square, but it is determined that the square is not blocked by an object in front of it, then the probability is reduced in the same way. The first probability and the maximum probability, in addition to other probabilities, may be displayed using any suitable type of representation, e.g. different colors, symbols etc.

### Step 703

This step corresponds to step 304 in FIG. 3. The registered surroundings based on LiDAR data enriched by the neural network may be visualized, i.e. the registered surroundings based on LiDAR data enriched by the neural network where the registered information has been classified into class objects in order to distinct between different types of objects 403, 500, 503, 601 in the surroundings. The visualization may be for example in the helm station 210. Visualization may comprise to display the registered surroundings based on LIDAR data enriched by the neural network in a display, e.g. comprised in or connected to the helm station 210.

The classified information may be disclosed as a 3D point cloud visualization with positional information and class information. The positional information may indicate the position of objects in the surroundings. The positional information may be comprised in the LiDAR data or determined based on the LiDAR data. The class information may indicate which class the object belongs to.

The classified information may be disclosed as a probability map. The probability map may comprise different colors or symbols representing different probabilities.

The probability map may be a 2D point cloud visualization with positional information and class information. The positional information may indicate the position of objects in the surroundings. The positional information may be comprised in the LiDAR data or determined based on the LiDAR data. The class information may indicate which class the object belongs to.

The probability map may be a 3D point cloud visualization with positional information and class information. The positional information may indicate the position of objects in the surroundings. The positional information may be comprised in the LiDAR data or determined based on the LiDAR data. The class information may indicate which class the object belongs to.

The classification may be done with a projection-based method for semantic classification of 3D point clouds.

Each point in the visualizations may be coloured with a colour of a class object or represented using any other type of representation as mentioned herein.

### Step 704

A decision may be made adapted to the visualized objects nearby the marine vessel 100, depending on their class objects. The decision may be such that:
a. if there is another marine vessel 500 within a predetermined distance, the speed of the marine vessel 100 may be triggered to be lowered below a predetermined speed to avoid getting too close to the other marine vessel 500, while,
b. if instead a dock 403 is registered, the marine vessel 100 may be allowed to drive faster than the predetermined speed when approaching the dock 403, since a dock 403 is not a movable object compared to the other marine vessel 100.

### Step 705

Input from a helm station 210 is obtained, i.e. input for manually controlling a driveline of the marine vessel 100. This may trigger the marine vessel to move accordingly.

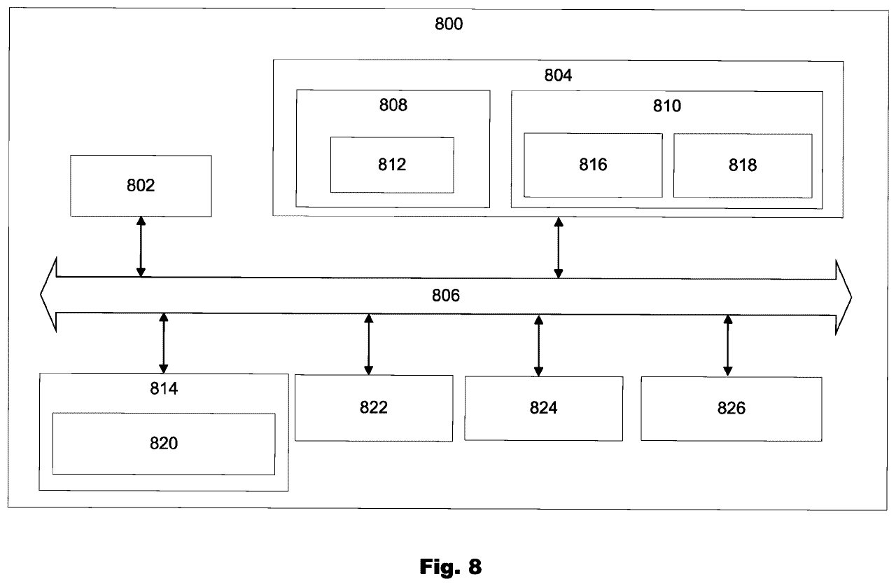

FIG. 8 is a schematic diagram of a computer system 800 for implementing examples disclosed herein. The computer system 800 is adapted to execute instructions from a computer-readable medium to perform these and/or any of the functions or processing described herein. The computer system 800 may be connected (e.g., networked) to other machines in a LAN, an intranet, an extranet, or the Internet. While only a single device is illustrated, the computer system 800 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, a control system may include a single control unit, or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 800 may comprise at least one computing device or electronic device capable of including firmware, hardware, and/or executing software instructions to implement the functionality described herein. The computer system 800 may include processing circuitry 802 (e.g., processing circuitry including one or more processor devices or control units), a memory 804, and a system bus 806. The computer system 800 may include at least one computing device having the processing circuitry 802. The system bus 806 provides an interface for system components including, but not limited to, the memory 804 and the processing circuitry 802. The processing circuitry 802 may include any number of hardware components for conducting data or signal processing or for executing computer code stored in memory 804. The processing circuitry 802 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 802 may further include computer executable code that controls operation of the programmable device.

The system bus 806 may be any of several types of bus structures that may further interconnect to a memory bus (with or without a memory controller), a peripheral bus, and/or a local bus using any of a variety of bus architectures. The memory 804 may be one or more devices for storing data and/or computer code for completing or facilitating methods described herein. The memory 804 may include database components, object code components, script components, or other types of information structure for supporting the various activities herein. Any distributed or local memory device may be utilized with the systems and methods of this description. The memory 804 may be communicably connected to the processing circuitry 802 (e.g., via a circuit or any other wired, wireless, or network connection) and may include computer code for executing one or more processes described herein. The memory 804 may include non-volatile memory 808 (e.g., read-only memory (ROM), erasable programmable read-only memory (EPROM), electrically erasable programmable read-only memory (EEPROM), etc.), and volatile memory 810 (e.g., random-access memory (RAM)), or any other medium which can be used to carry or store desired program code in the form of machine-executable instructions or data structures and which can be accessed by a computer or other machine with processing circuitry 802. A basic input/output system (BIOS) 812 may be stored in the non-volatile memory 808 and can include the basic routines that help to transfer information between elements within the computer system 800.

The computer system 800 may further include or be coupled to a non-transitory computer-readable storage medium such as the storage device 814, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 814 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 814 and/or in the volatile memory 810, which may include an operating system 816 and/or one or more program modules 818. All or a portion of the examples disclosed herein may be implemented as a computer program 820 stored on a transitory or non-transitory computer-usable or computer-readable storage medium (e.g., single medium or multiple media), such as the storage device 814, which includes complex programming instructions (e.g., complex computer-readable program code) to cause the processing circuitry 802 to carry out actions described herein. Thus, the computer-readable program code of the computer program 820 can comprise software instructions for implementing the functionality of the examples described herein when executed by the processing circuitry 802. In some examples, the storage device 814 may be a computer program product (e.g., readable storage medium) storing the computer program 820 thereon, where at least a portion of a computer program 820 may be loadable (e.g., into a processor) for implementing the functionality of the examples described herein when executed by the processing circuitry 802. The processing circuitry 802 may serve as a controller or control system for the computer system 800 that is to implement the functionality described herein.

The computer system 800 may include an input device interface 822 configured to receive input and selections to be communicated to the computer system 800 when executing instructions, such as from a keyboard, mouse, touch-sensitive surface, etc. Such input devices may be connected to the processing circuitry 802 through the input device interface 822 coupled to the system bus 806 but can be connected through other interfaces, such as a parallel port, an Institute of Electrical and Electronic Engineers (IEEE) 1394 serial port, a Universal Serial Bus (USB) port, an IR interface, and the like. The computer system 800 may include an output device interface 824 configured to forward output, such as to a display, a video display unit (e.g., a liquid crystal display (LCD) or a cathode ray tube (CRT)). The computer system 800 may include a communications interface 826 suitable for communicating with a network as appropriate or desired.

A computer program product comprising program code for performing, when executed by a processing circuitry 802, the method described herein. A non-transitory computer-readable storage medium comprises instructions, which when executed by a processing circuitry 802, cause the processing circuitry 802 to perform the method described herein.

Example 1: A marine surround sensing system for controlling a marine vessel (100), wherein the marine surround sensing system comprises:
Light Detection And Ranging, LiDAR, sensors (201) mounted around the marine vessel (100) for registering surroundings of the marine vessel (100), wherein the surroundings comprise obstacles (303, 500, 503, 601) and water (305),
a control unit (205) with neural network to process info about the registered surroundings which has been registered by the LiDAR sensors,
where the control unit (205) is programmed to visualize the registered surroundings based on LiDAR data enriched by the neural network where the registered information has been classified into class objects in order to distinct between different types of objects (303, 500, 503, 601) in the surroundings.

Example 2: The marine surround sensing system according to example 1, comprising:
a helm station (210) to visualize the registered surroundings and to provide input for manually controlling a driveline of the marine vessel (100),

Example 3: The marine surround sensing system according to any of examples 1-2, wherein the classified information is disclosed as a three dimensional, 3D, point cloud visualization with positional information and class information.

Example 4: The marine surround sensing system according to any of examples 1-3, wherein the classified information is disclosed as a probability map.

Example 5: The marine surround sensing system according to example 4, wherein the probability map is a three dimensional, 3D, point cloud visualization with positional information and class information.

Example 6: The marine surround sensing system according to example 4, wherein the probability map is a two dimensional, 2D, point cloud visualization with positional information and class information.

Example 7: The marine surround sensing system according to one of the preceding examples, wherein the classification is done with a projection-based method for semantic classification of a three dimensional, 3D, point cloud.

Example 8: The marine surround sensing system according to one of the preceding examples, wherein each point in the visualizations is coloured with a colour of a class object.

Example 9: The marine surround sensing system according to one of the preceding examples, wherein the control unit (205) is arranged to make decisions adapted to the visualized objects (303, 500, 503, 601) nearby the marine vessel (100) depending on their class objects.

Example 10: The marine surround sensing system according to examples 9, wherein the control unit (205) is arranged to make decisions in such a way that:
a. if there is another marine vessel (500) within a predetermined distance, the control unit (205) automatically lowers the speed of the marine vessel (100) below a predetermined speed to avoid getting too close to the other marine vessel (500), while,
b. If instead a dock (303) is registered, the marine vessel (100) if appropriate is allowed to drive faster than the predetermined speed when approaching the dock (303), since a dock (303) is not a movable object compared to the other marine vessel (500).

Example 11: A marine vessel (100) comprising the marine surround sensing system according to one of the preceding examples.

Example 12: A computer implemented method for controlling a marine vessel (100), the method comprising:
obtaining (300, 701) information about registrations of the surroundings of the marine vessel (100), wherein the registering is performed by Light Detection And Ranging, LiDAR, sensors (201) mounted around the marine vessel (100), wherein the surroundings comprise obstacles (303, 500, 503, 601) and water (305);
processing (301, 302, 303, 702), using a neural network, information about the registered surroundings which has been registered by the LiDAR sensors; and
visualizing (304, 703) the registered surroundings based on LiDAR data enriched by the neural network where the registered information has been classified into class objects in order to distinct between different types of objects (303, 500, 503, 601) in the surroundings.

Example 13: The method according to examples 12, wherein the classified information is disclosed as a 3D point cloud visualization with positional information and class information.

Example 14: The method according to any of examples 12-13, wherein the classified information is disclosed as a probability map.

Example 15: The method according to examples 14, wherein the probability map is a 2D point cloud visualization with positional information and class information.

Example 16: The method according to examples 14, wherein probability map is a 3D point cloud visualization with positional information and class information.

Example 17: The method according to any of examples 12-16, wherein the classification is done with a projection-based method for semantic classification of 3D point clouds.

Example 18: The method according to any of examples 12-17, comprising: making (704) decisions adapted to the visualized objects nearby the marine vessel (100) depending on their class objects.

Example 19: A computer program product comprising program code for performing, when executed by a processing circuitry (802), the method of any of examples 12-18.

Example 20: A non-transitory computer-readable storage medium comprising instructions, which when executed by a processing circuitry (802), cause the processing circuitry (802) to perform the method of any of examples 12-18.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

It is to be understood that the present disclosure is not limited to the embodiments described above and illustrated in the drawings; rather, the skilled person will recognize that many changes and modifications may be made within the scope of the appended claims.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A marine surround sensing system for controlling a marine vessel, wherein the marine surround sensing system comprises:
Light Detection And Ranging, LiDAR, sensors mounted around the marine vessel for registering surroundings of the marine vessel, wherein the surroundings comprise obstacles and water,
a control unit with a neural network to process information about the registered surroundings which has been registered by the LiDAR sensors, wherein the information registered by the LiDAR sensors is in the form of a 3D point cloud, wherein the processing comprises:
a first projection, by the control unit, of the 3D point cloud into one or two 2D maps;
segmentation, by the neural network in the control unit, of the one or two 2D maps, wherein an output of the segmentation is a segmented 2D map with class information for each point in the one or two 2D maps; and
a second projection, by the control unit of the segmented 2D map back to the 3D point cloud; and,
where the control unit is programmed to visualize the registered surroundings based on LiDAR data enriched by the neural network by displaying an image or map representing the 3D point cloud from the second projection, and wherein the enrichment comprises classification of the registered information into class objects in order to distinct between different types of objects in the surroundings,
wherein the control unit is arranged to make decisions adapted to the visualized objects nearby the marine vessel depending on their class objects.

2. The marine surround sensing system according to claim 1, comprising:
a helm station to visualize the registered surroundings and to provide input for manually controlling a driveline of the marine vessel,

3. The marine surround sensing system according to claim 1, wherein classified information from the classification is disclosed as a three dimensional, 3D, point cloud visualization with positional information and class information.

4. The marine surround sensing system according to claim 1, wherein the classified information from the classification is disclosed as a probability map.

5. The marine surround sensing system according to claim 4, wherein the probability map is a two dimensional, 2D, point cloud visualization with positional information and class information.

6. The marine surround sensing system according to claim 4, wherein the probability map is a three dimensional, 3D, point cloud visualization with positional information and class information.

7. The marine surround sensing system according to claim 1, wherein the classification is done with a projection-based method for semantic classification of a three dimensional, 3D, point cloud.

8. The marine surround sensing system according to claim 1, wherein each point in the visualizations is coloured with a colour of a class object.

9. (canceled)

10. The marine surround sensing system according to claim 1, wherein the control unit is arranged to make decisions in such a way that:
a. if there is another marine vessel within a predetermined distance, the control unit automatically lowers the speed of the marine vessel below a predetermined speed to avoid getting too close to the other marine vessel, while,
b. If instead a dock is registered, the marine vessel is allowed to drive faster than the predetermined speed when approaching the dock, since a dock is not a movable object compared to the other marine vessel.

11. A marine vessel comprising the marine surround sensing system according to claim 1.

12. A computer implemented method for controlling a marine vessel, the method comprising:
obtaining information about registrations of the surroundings of the marine vessel, wherein the registering is registrations are performed by Light Detection And Ranging, LiDAR, sensors mounted around the marine vesse, wherein the surroundings comprise obstacles and water, wherein the obtained information is in the form of a 3D point cloud;
processing, using a neural network, information about the registered surroundings which has been registered by the LiDAR sensors, wherein the processing comprises:
performing, by the control unit, a first projection by projecting the 3D point cloud into one or two 2D maps;
performing, by the neural network in the control unit, segmentation of the one or two 2D maps, wherein an output of the segmentation is a segmented 2D map with class information for each point in the one or two 2D maps; and
performing, by the control unit, a second projection by projecting the segmented 2D map back to the 3D point cloud;
visualizing the registered surroundings based on LiDAR data enriched by the neural network by displaying an image or map representing the 3D point cloud from the second projection, wherein the enrichment comprises to classify_the registered information into class objects in order to distinct between different types of objects in the surroundings; and
making decisions adapted to the visualized objects nearby the marine vessel depending on their class objects.

13. The method according to claim 12, wherein the classified information is disclosed as a 3D point cloud visualization with positional information and class information.

14. The method according to claim 12, wherein the classified information is disclosed as a probability map.

15. The method according to claim 14, wherein the probability map is a 2D point cloud visualization with positional information and class information.

16. The method according to claim 14, wherein probability map is a 3D point cloud visualization with positional information and class information.

17. The method according to claim 12, wherein the classification is done with a projection-based method for semantic classification of 3D point clouds.

18. (canceled)

19. A computer program product comprising program code for performing, when executed by a processing circuitry, the method of claim 12.

20. A non-transitory computer-readable storage medium comprising instructions, which when executed by a processing circuitry, cause the processing circuitry to perform the method of claim 12.
